(19) United States
(12) Patent Application Publication
(10) Pub. No.: US 2003/0052227 A1
(43) Pub. Date: Mar. 20, 2003

(54) Protective shield for aircraft cockpit crew

(76) Inventor: Donald Merve Pittman, Merritt Island, FL (US)

Correspondence Address: DONALD M. PITTMAN, 4780 SEMINOVE TRAIL, MERRITT ISLAND, FL, 32953, US

(21) Appl. No.: 10/245,198

(22) Filed: Sep. 17, 2002

Related U.S. Application Data
(60) Provisional application No. 60/322,769, filed on Sep. 17, 2001.

(51) Int. Cl. B64D 11/00; B64D 13/00

(52) U.S. Cl. 244/118.5

(57) ABSTRACT

This invention relates generally to the field of aircraft technology and systems utilized for protection of aircraft, occupants, and operators thereof from hijackers, terrorists, and other anomalous problems while in flight. More particularly, the present invention relates to a device used in conjunction with walls, floor, and ceiling of a cockpit's entry/exit passageway for protecting the cockpit crew from weapons, hostility, decompression, and/or physical intrusions. A light weight protective shield for the cockpit of an aircraft (i.e. bullet-proof door) along with a internal locking and release device, none of which is provided by prior art. The protective shield can absorb repeated blows, provide pressure relief in the event of aircraft decompression, resist penetration of firearms, knives, and explosive devices, and is compliant with FAA regulations. The protective shield provides a new level of protection for the crew of a passenger or cargo airplane and protects the cockpit of an aircraft from hijacking attempts as well as other anomalous events and is comprised of a light weight weapon-proof protective shield that when closed fits snugly with the flight deck's adjoining floor, walls, and ceiling. This protective shield system is intended to readily install inside existing aircraft (e.g. over-night retrofit installation) or be installed into new aircraft as they are assembled.

The priority and benefit of U.S. Provisional Application No. 60/322,769, filed on Sep. 17, 2001 by Donald M. Pittman and entitled Protective Shield for Aircraft Cockpit Crew is hereby claimed, and said Provisional Application is incorporated herein by reference for all purposes.

### BACKGROUND OF THE INVENTION

1. Field of the Invention

This invention relates generally to the field of aircraft technology and systems utilized for protection of aircraft, occupants, and operators thereof from hijackers, terrorists, and other anomalous problems while in flight.

More particularly, the present invention relates to a device used in conjunction with walls, floor, and ceiling of a cockpit's entry/exit passageway for protecting the cockpit crew from weapons, hostility, decompression, and/or physical intrusions.

2. Description of the Prior Art

Devices and assemblies that provide simple partitions and doors within an aircraft to divide areas into compartments are well known in the art. An aircraft normally contains a plurality of partitions to divide one section from another. These partitions and doors are used to segregate the cockpit from the main cabin, as well as segregate and isolate the galleys and lavatories from the other sections of the aircraft.

U.S. Pat. No. 5,577,358 (Franke) discloses a separation wall for dividing a cabin space inside a passenger aircraft. The separation wall is constructed of two elements rigidly connected to one another via at an overlap area interface. An aircraft's cabin can be divided with such separation walls thereby creating the appearance of distinct areas within the passenger compartment.

A tactical shield system for shielding a doorway or window is disclosed in U.S. Pat. No. 5,939,658 (Muller). The tactical shield system includes an armored curtain and a hook and loop fastening method. In specific situations, such as a hostage stand-off or a drug raid, the requirement to storm a building that contains potentially dangerous personnel is present. The portable armored curtain would provide protection for tactical teams during the act of battering down a door to gain access to a building.

U.S. Pat. No. 6,257,523 (Olliges) discloses a stowable aircraft cabin vertical partition made of at least three rigid horizontal panels attached to each other by hinges along it's joints; a partition support is attached near its top edge and a stowage support which holds the fan-folded partition for stowage; wherein a portion of the panels form a vertically hinged compartment access door having a sufficient number of vertical and horizontal hinges to keep the panels of the access door in a planar alignment with each other when the partition is in use and fan-folded upon stowage. Privacy is provided with such a partition in areas previously not utilized, such as the area adjacent to the side doorway, wherein a passenger may change clothes or sleep during long flights.

Major problems associated with prior art devices include, among others, the inherent inability to provide a level of protection to the crew operating the aircraft. Armored doors such as those installed aboard submarines, tanks, and maritime tanker vessels are far too heavy for aircraft and do not meet FAA regulations. In addition, major problems associated with prior art includes their inability to serve as a barrier to prevent hostile intrusion by hijackers as well as penetration by weapons (gun, knife, etc.).

Typically, a single panel (door) or pair of folding partition panels (bi-fold doors) has separated the crew from their passengers. These single panel or bi-fold doors have served principally for privacy or segregation not as protection for the crew from anyone with malicious intent. Of critical importance is protection of the crew who operate the aircraft for their numerous passengers. An aircraft overtaken by hijacking terrorists is transformed from a transportation vehicle into a weapon capable of mass destruction. It is desirable, therefore, to provide all aircraft capable of carrying passengers and cargo with an effective means to prevent persons that might be present aft of the flight deck from gaining access to the flight deck or otherwise creating aircraft problems that might adversely affect the flight crew and create a danger to the aircraft, the passengers, the flight crew or persons and property on the ground.

What is still needed, therefore, is a protective shield that can serve as a door with a relatively tight fit in the entranceway of an aircraft's cockpit. The protective shield will preferably be lightweight, high strength, and readily installed in an aircraft. Furthermore, the protective shield will preferably absorb repeated blows from hijackers, relieve pressure in the event of rapid decompression, as well as resist penetration from firearms and explosive devices without degradation in its armored protection. What is also desired is that the protective shield meet the regulations defined by the Federal Aviation Administration. Such a protective shield would be permanently installed as a door or a component of a door in the entranceway of the cockpit and is secured to the local structure, i.e. flight deck bulkhead of an aircraft.

### SUMMARY OF THE INVENTION

The invention described herein provides a light weight protective shield for the cockpit entranceway of an aircraft (i.e. bullet-proof door) along with a internal locking and release device, none of which is provided by prior art. Furthermore, the invention described herein can absorb repeated blows, provide pressure relief in the event of aircraft decompression, resist penetration of firearms, knives, and explosive devices, and is compliant with FAA regulations. Accordingly, a general object of the present invention is to provide a new level of protection for the crew of a passenger or cargo airplane.

The invention described herein eliminates or substantially reduces in critical importance the problems with the prior art by providing a system by which the aircraft cockpit is protected from terrorist aggressions and weapons. Accordingly, the invention being presented complies with the Special Federal Aviation Regulation (SFAR) 92, introduced Oct. 9, 2001, which requires installation of internal locking devices on flight deck compartment doors. Furthermore, the invention described herein complies with Public Law 107-71, the Aviation and Transportation Security Act, henceforth referred to as the Act, which was enacted by the United States Congress on Nov. 19, 2001. Section 104 of the Act required the Federal Aviation Administration (FAA) to issue requirements to improve flight deck integrity, specifically the strengthening of the flight deck door. On Jan. 15, 2002, the FAA issued Amendment 25-106 that adds new intrusion resistance and ballistic penetration requirements to part 25. Concurrently, the FAA also issued Amendment 121-288 that requires part 121 passenger and cargo operators to have strengthened flight deck doors installed on these airplanes by Apr. 9, 2003.

Systems represented by prior art are not suitable for adaptation into aircraft security applications for a number of reasons. The most important reasons directly relate to the prior art's inability to withstand penetration from a weapon and their inability to resist physical intrusion and yet release in the event of rapid cabin decompression. The Federal Aviation Administration (FAA) safety regulations also require that internal doors (or door panels) of aircraft release themselves automatically in either direction under conditions of a pressure differential (i.e. decompression).

Rapid loss of cabin pressure (i.e. decompression) corresponds to a threshold value of 0.11 psig or approximately 175 lb_{f}, in order to avoid excessive internal pressure differentials that could lead to structural failure of the aircraft. Additionally, there is a need for a protective cockpit system that can withstand an attempted forced entry of up to 1,100 lb_{f}. The door's center, latch, and hinges must endure three impacts of at least 200 joules. Additionally, the door must withstand a 9-mm or 0.44 magnum bullet, according to N. I. J. threat level IIIA standards or a NATO M26 grenade when detonated at a distance of 8 inches. And the door must withstand repeated blows with an aircraft crash axe.

Another object of the invention presented herein includes a subsystem that senses a rate of differential pressure, or rate of inertia, and would thereby automatically release the decompression panel or the door lock mechanism in the event of rapid decompression in the cabin.

A further object of the present invention is to withstand the penetration of specific firearms and axes. In addition, the invention presented herein also has the ability to withstand an attempted physical breach into the cockpit. All of the aforementioned government regulations are met by this invention and other features that are considered appropriate to protection of the passengers, crew and aircraft, and to maintain control of the aircraft solely by the crew are provided by the present invention.

The improvements and capabilities offered by the device, mechanism or system of the present invention is it's novelty, protective features (against weapons, decompression, and intrusion), obviousness, simplicity of design, light weight, robustness, strength, unobviousness, ease of manufacture, long sought need, immediate marketability, broad scope of commercialization, and efficiency in which it performs its intended function.

In accordance with the foregoing principles and objects of the present invention, a system for protecting the cockpit of an aircraft from unauthorized intrusion is described which basically comprises a generally high strength panel and suitable components which constitute a protective barrier that resists forcible breach and entry by means designated in current governmental regulations.

According to the teachings of the present invention there is provided a device comprised of four primary components or subsystems that facilitate the installation of a high-strength protective door, or shield, in the cockpit entrance(s) of an aircraft. The four main components include a light weight bullet-proof protective shield or door; that is mounted within a high strength perimeter frame and employs an efficient and effective locking/release mechanism with manual and command actuated release, and a method for attaching the door or shield to the surrounding high strength perimeter frame.

According to the principles of the present invention two general embodiments of the invention comprise (1) a roll-type shield, with tubular cross-members, lock/release mechanism, guide tracks, and housing; or (2) a hinged panel-type shield, having a lock/release mechanism, hinges, and latches for its mounting and secure closure within an aircraft.

Recent FAA requirements issued since the Sep. 11, 2001 events and previously referred to in the Background section of this Utility Patent Application (e.g. SFAR 92, The Act, Amendment 25 and 121) have identified specified parameters that are most logically accomplished by a hinged panel type protective door mechanism. Accordingly the preferred embodiment of the present invention is [the] a hinged panel type protective door. In practice, either a single panel door or a multiple panel partition door (typically comprised of two panels thus creating a bi-fold door) is installed in the entranceway of the cockpit or flight deck of an aircraft. A significant number of large late model airplanes have existing structure that will readily accommodate the hinged single panel protective door. The alternative embodiment is a roll-type of protective door. Each embodiment is presented within this Specification, with the hinged single panel door being emphasized as the preferred embodiment of this invention.

This novel system of the present invention is for protecting the cockpit of an aircraft from hijacking attempts as well as other anomalous events that might be attempted by unauthorized persons to gain access to an aircraft cockpit and is comprised of a light weight weapon-proof protective shield that, when closed, fits snugly with the flight deck's adjoining floor, walls, and ceiling.

This protective shield system is intended to be readily installed inside existing aircraft (e.g. over-night retrofit installation) or be installed into new aircraft as they are assembled. The obviousness, as well as the unobviousness, of this protective shield system will become apparent upon review of this Specification.

The advantages and distinctions of the present invention over prior art will become clearly evident.

In view of the above, it is the aim of the invention to achieve the following objects either singly or in combination:

To provide a device that facilitates the closure of a weapon-proof and intrusion-proof shield near the flight deck inside an aircraft.

It is a further object of the present invention is to a device that is light-weight yet strong and easy to use for the aforementioned purpose.

Another object of the present invention is to a system that offers a new level of protection to aircraft pilots from acts of terrorism aboard their aircraft.

It is yet another object of the present invention is to a device that facilitates strong latches and hinges (or tracks) that resist physical force and yet release in the event of anomalous aircraft decompression.

Another object of the invention is to provide a device with either a decompression panel or door that has automatic pressure relief in the anomalous event of cabin decompression.

Still another object of the present invention is to provide a device that is readily manufactured, assembled, and installed.

Yet another object of the present invention is to provide a device that primarily utilizes commercial off the shelf equipment, can be mass produced at a reasonable cost, is highly reliable, and is readily installed into existing aircraft, as well as those under construction.

These and other objects of the invention as well as its particular features will become more apparent from the following detailed description of its embodiments considered with reference to the accompanying drawings.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a partial sectional view in plan, illustrating the flight deck area of a large aircraft, emphasizing the cockpit bulkhead of the aircraft and showing a security cockpit door which, when closed and secured, isolates the crew of the aircraft from all other persons aboard the aircraft;

FIG. 2 is an elevational illustration showing a protective cockpit security door from the passenger cabin perspective which embodies the principles of the present invention;

FIG. 3 is an elevational illustration showing a protective cockpit security door from the cockpit side of the door and illustrating a protective shield system of the door;

FIG. 4a is an isometric illustration showing a portion of the protective cockpit security door of FIG. 3 and showing the decompression panel with its deadbolt extended for locking with respect to the door structure;

FIG. 4b is an isometric illustration similar to that of FIG. 4a and showing a portion of the protective cockpit security door with the decompression panel being shown with its deadbolt retracted for unlocking and showing the decompression panel being pivoted to its open position;

FIG. 4c is an isometric illustration showing a portion of the protective cockpit security door of FIG. 3 and further showing a door knob actuated deadbolt and a manual lever actuated deadbolt, each in their extended positions for latching the protective cockpit security door in its closed position;

FIG. 4d is another isometric illustration showing the door knob actuated deadbolt and a manual lever actuated deadbolt, each in their retracted positions to permit opening of the protective cockpit security door by the aircraft crew;

FIG. 5a is a side view of a portion of the decompression panel of FIGS. 4a and 4b with the decompression mechanism thereof shown in the neutral or non-activated position;

FIG. 5b is a similar side view of a portion of the decompression panel of FIGS. 4a and 4b with the decompression mechanism thereof shown in the decompression activated position thereof;

FIG. 6 is an isometric illustration showing a pneumatically actuated deadbolt mechanism for latching and releasing the decompression panel of FIGS. 4a and 4b, showing the manual release levers and the deadbolt mechanism being shown with the deadbolts extended to the latching positions thereof;

FIG. 7 is an isometric illustration showing the pneumatically actuated deadbolt mechanism of FIG. 6 with the manual release levers and deadbolts thereof being retracted to the release positions thereof;

FIG. 8a is an isometric illustration showing the locking sequence for the door knob and manual release lever mechanisms of FIG. 4c, being shown in the latching positions thereof;

FIG. 8b is an isometric illustration similar to FIG. 8a and showing the unlocking sequence with the deadbolt latches in the retracted or release positions thereof;

FIG. 8c is an isometric illustration showing the locking sequence for the pneumatically actuated deadbolt mechanism of FIG. 6 with the release levers and deadbolts thereof being shown in the extended or latched positions thereof;

FIG. 8d is a similar isometric illustration showing the unlocking sequence for the pneumatically actuated deadbolt mechanism of FIG. 6 with the deadbolts and release levers thereof being shown in the retracted or unlocking positions thereof;

FIG. 9 is an elevational illustration showing a protective bi-fold door embodying the principles of the present invention and representing the view of the bi-fold door from the passenger cabin of an aircraft;

FIG. 10 is an elevational view similar to FIG. 9 and showing the protective bi-fold door from the cockpit perspective of the aircraft;

FIG. 11 is an isometric illustration showing a portion of the protective bi-fold door of FIGS. 9 and 10 and showing pneumatically actuated deadbolt mechanisms in each decompression actuated door panel, with the deadbolts and release levers thereof being shown in their extended or latching positions;

FIG. 12 is an elevational view showing a protective roll-type door embodying the principles of the present invention, the view showing the protective shield from the passenger cabin;

FIG. 13 is an elevational view showing the protective shield of FIG. 12 from the cockpit side;

FIG. 14 is an elevational view showing a portion of the protective shield of FIGS. 12 and 13 and showing a manual locking mechanism of the protective shield and showing a decompression actuated lock release mechanism;

FIG. 15a is a partial sectional end view showing a C-channel guide track and protective door of FIGS. 12 and 13;

FIG. 15b is a sectional top view showing the protective door of FIGS. 12 and 13, a security bar of FIGS. 13 and 14, and a tensioning coil type mechanism contained within a hinged stowage container housing.

### DETAILED DESCRIPTION OF PREFERRED EMBODIMENT

The present invention is a protective system particularly suited to the requirement of security for the crew members controlling an aircraft, although components of the invention may equally be applied to a range of other applications. The principles and operation of security systems according to the present invention may be better understood with reference to the drawings provided herein and their accompanying description.

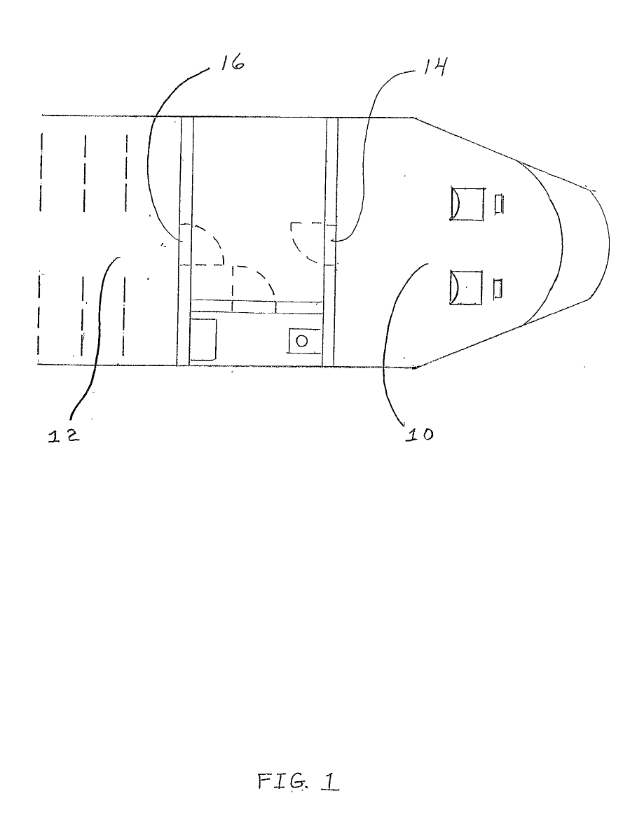

Referring now to the drawings, FIG. 1 shows a typical forward fuselage aircraft layout in which a cockpit 10 is divided from the passenger area 12 by a secure door 14. According to increasingly stringent security requirements, door 14 is preferably weapon-proof and locked in a manner sufficient to secure it against forceful breaching by a terrorist. Additional precautions taken by certain airlines include a second flight deck door 16, is provided a space from door 14, wherein a lavatory and/or separate galley can be provided. Door 16 allows implementation of additional precautions through which the pilot or co-pilot is never within sight of the passengers. Thus, prior to opening door 14 for any reason, door 16 is first closed.

This lightweight yet strong protective shield system comprises a generally rectangular door section of size corresponding to the aircraft flight deck's entranceway. This rectangular section can be comprised of a single panel or multiple vertical panels or partitions (e.g. bi-fold door) if necessary for particular aircraft, or of a single sheet panel that is rolled vertically into and out of position.

The preferred embodiment of the present invention is that of a hinged panel-type shield. The panel can be either singular and thus resembles a door or it can have multiple panels such as a bi-fold door. The panel-type door includes an automated release subsystem and/or decompression panels. At the time of submitting this patent application, the latest FAA regulations required that either the door itself or the door's decompression panel would automatically release if a differential pressure (flight deck compared with cabin) greater than 0.11 psig (corresponding to rapid decompression) is sensed. By doing so, this would alleviate the possibility of adverse pressure gradients that could lead to structural failure.

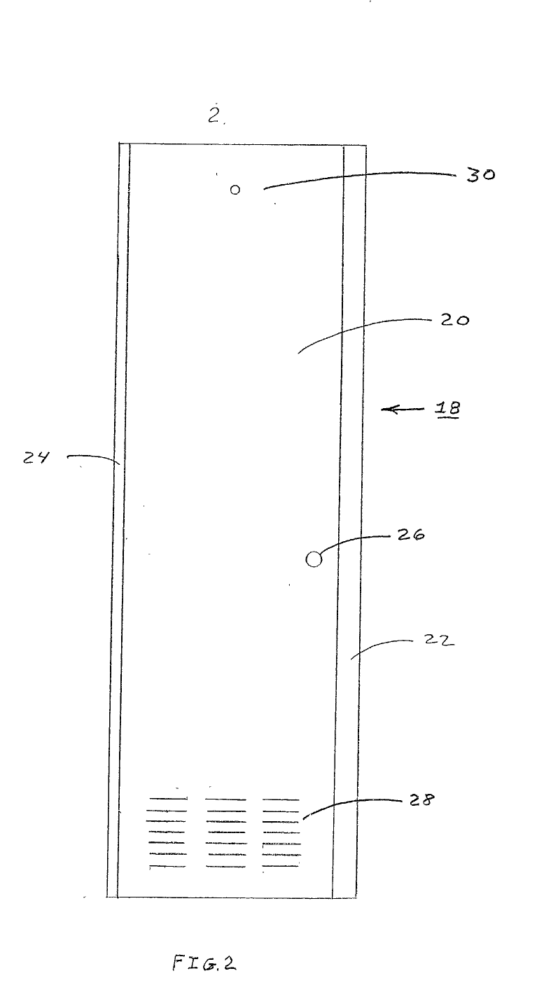

Referring also to FIG. 2, the protective door system 18 is shown as would be seen from the cabin side of the aircraft. Surrounding the protective door 20 is a strengthened door frame comprised of door jamb 22, and vertical frame 24. The strengthened door frame is secured to the aircraft structure via a plurality of fasteners per standard aircraft procedures. The door frame is made with high strength materials such as stainless steel, aluminum alloy, and titanium.

The protective door 20 is manufactured with composite materials such as “Spectra” or “Kevlar” or “Gold” (and may include the patent pending multiplayer composite material known as “TelAir”). The light-weight yet weapon-proof protective door 20 is typically manufactured with face sheet(s) on the surface (cabin side, cockpit side), a phenolic hex core, a ballistic phenolic core, and cres wire mesh layers. A suitable high strength framing is utilized around the perimeter of the weapon-proof door 20.

A door knob 26 is provided on the cabin side. The door 20 is swung opened and closed in a conventional manner. The door knob is relatively small in diameter so that a large amount of pull force cannot be attained. This door knob has a auxiliary dead latch bolt, thereby providing an additional level of security for the automated lock/release deadbolt mechanism. The door knob could have a security feature that could include any one of the following methods for its lock and release; coded key (one key issued to each airline/aircraft and tightly configuration-controlled), coded touch-pad (numeric or alpha-numeric), iris scan of eyeball (optical device), or finger-print scan (optical device).

As viewed from the cabin side, a decompression panel is located in the general area where the louvers 28 are seen. The louvers are made from a ballistic-proof material. In the event of the anomalous event known as decompression, the louvers allow the differential pressure to trigger its automated release mechanism. At the time of submitting this patent application, the FAA requires a decompression panel in the strengthened cockpit doors.

Near the top of the door is an optical view port 30, equipped with a wide angle lens. This viewing port can be utilized by a flight deck crew member to see into the passenger area of the cabin. In addition, a closed circuit digital video camera can be mounted in the panel-type door to allow the crew to monitor passengers in the cabin.

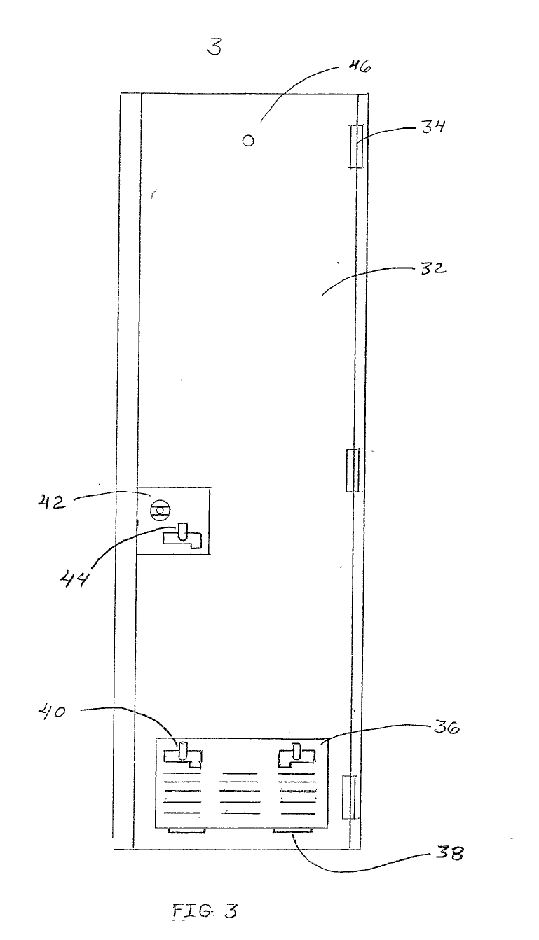

Next in FIG. 3, the protective shield system 18 is shown from the cockpit side. Like components of reference substructure are comprised of components 20, 22, and 24. The protective door 32 is secured to the vertical frame 24 via a plurality of high strength hinges 34. Three hinges are shown in FIG. 3. Location of the hinges is concealed from view from the cabin side by the door's framing. The hinges are made from a weapon-proof material such as titanium.

Within the rectangular section of the protective door itself is decompression panel (required at the time of this patent application, may be optional if a similar feature is required on the door latch, depending on future FAA regulations before April, 2003). If the current FAA regulations remain unchanged, then only one component (the decompression panel) would need to automatically release. The cross-sectional area of the decompression panel corresponds to loss of a cabin window or cockpit windshield section and may be considered an escape route by crew-members (one of two escape routes, other route may be windshield panel or escape hatch depending upon model of aircraft).

A unique lock/release system is mounted in the panel-type door. A decompression emergency panel 36 is shown and is attached along the bottom edge via a strengthened hinge 38. The autonomous mechanical assembly in the decompression normally has its deadbolts out in the extended position, thereby securing the panel in place. The decompression panel's pneumatic system will automatically release its respective component if a specified pressure differential is sensed. There is also a manually operated provision enabled by the lever arm 40 to release the decompression panel. Two lever arms are depicted in FIG. 3, one for each deadbolt actuator. The lock/release system can be operated from the inside of the flight deck by a cockpit crew member to close or release its deadbolt bars.

An interior door knob 42 and decompression mechanism 44 are also shown in FIG. 3. This door knob has a auxiliary dead latch bolt, thereby providing an additional level of security for the automated lock/release deadbolt mechanism. The strike plate and doorjamb are reinforced as well, utilizing high strength material. This automated decompression mechanism is similar to the one employed for the decompression panel except that it requires only one deadbolt. When the release lever is manually over to its detent position, the deadbolt is extracted from the door jamb. The pneumatic actuator that the release lever acts upon is normally extended due to its captive coil spring. In the event of decompression, the automated bellows mechanism would release this deadbolt. The door knob could have a security feature that could include a coded key (one key issued to each airline/aircraft and tightly configuration-controlled) or a dual lever lock (rotatable from cockpit side to conceal key hole on cabin side).

A view port 46 with wide angle lens is provided for the fight deck crew member to observe what the status is in the cabin area. An optional closed circuit digital camera could be utilized as well to provide real-time video to a monitor screen in the flight deck, as well as recorded images for future documentation if desired.

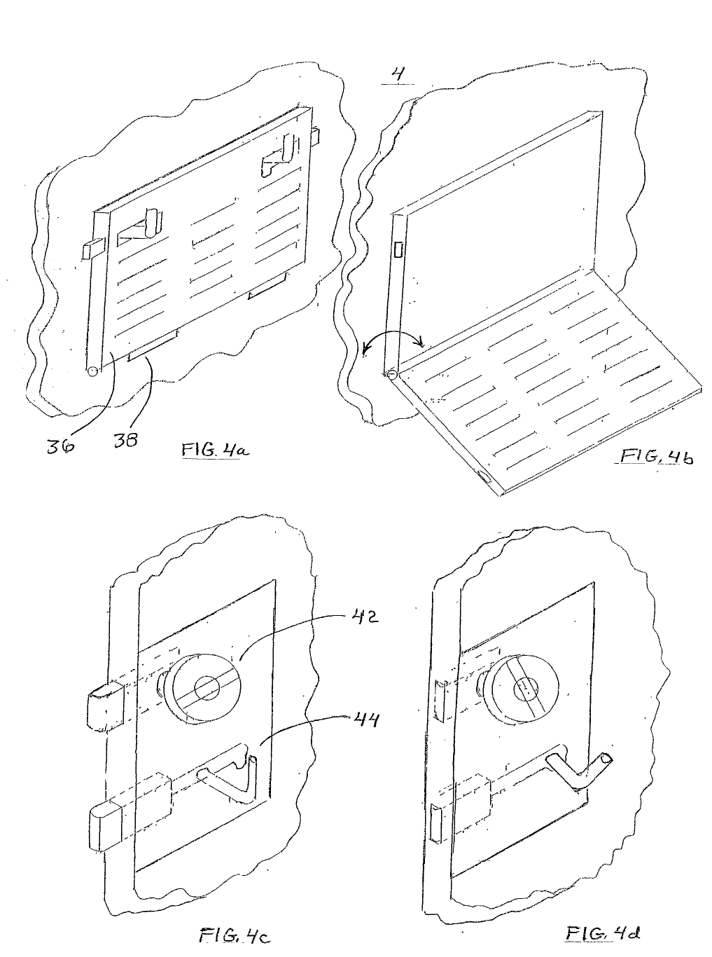

A series of locked and released depictions are provided in FIG. 4. FIG. 4a shows the decompression panel with its deadbolt extended in the normally closed position. FIG. 4b shows the decompression panel with its deadbolt retracted in the decompression or crew-escape position. In FIG. 4c, the door knob/deadbolt and manual lever for their decompression system are shown in the closed position. In FIG. 4d, the door knob/deadbolt and manual lever for their decompression system are shown in the open position.

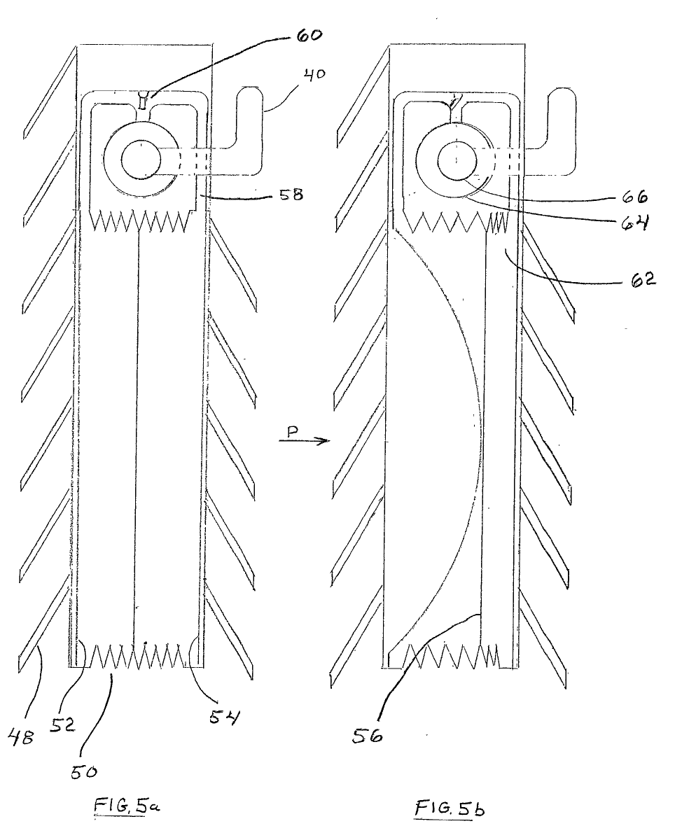

Referring to FIG. 5a and 5b, the unique decompression mechanism is shown in an end view. FIG. 5a shows the normal or neutral position, while FIG. 5b shows the activated or decompression position. The decompression position shown is one during which the pressure (depicted by P) is moving in the direction of the cockpit, although the panel is hinged such that rotation in either direction is possible. Therefore, decompression movement in the other direction, toward the cabin, is also accommodated for with this device.

Louvers 48 are provided on each side of the decompression mechanism. These louvers are made from ballistic-proof material on the cabin side. Lighter yet heavy-duty louvers are installed on the flight deck side of the decompression panel, along with a manual release lever 40. The automated release mechanism for the panel type door is comprised of a compact subsystem that is configured with a unique metallic bellows-type diaphragm that reacts to the cockpit and cabin pressures. This automated release mechanism is purely mechanical by nature.

This diaphragm 50 is an accordion type of bellows device. The mating membrane cover 52 and 54 are made of a resilient material of a thickness that provides a fast reaction time to a pressure differential associated with decompression (typical threshold value of 0.11 psig). The inner diaphragm 56 is a stiff material and is utilized to compress the volume on its opposite side. The actuation systems itself is a closed system containing a pressurized inert gas (e.g. gaseous nitrogen at a pressure of 14.7 psi).

In the event of rapid decompression, the differential pressure (P) causes the diaphragm cover 52 to deform in such a way that the inner membrane 56 is moved by differential pressure in a direction toward the cockpit of the aircraft. The membrane 56 and backpressure applied by the diaphragm cover causes the bellows to move laterally thereby compressing the contained inert gas in the bellows. The compressed inert gas is routed via the line 58 to the flapper valve 60 and on into the actuator 64 where the actuator's plunger 66 retracts thereby extracting the deadbolt from the protective door's housing and thereby allowing the decompression panel to rotate downward onto the floor of the flightdeck.

The volume of the bellows is far greater than that of the pneumatic actuator, the destination of the compressed air. When a specific threshold of differential pressure (e.g. 0.11 psig) is sensed then the diaphragm is forced into a convex shape and displaces the bellows as shown in FIG. 5b. A flapper valve is located at the junction of the distribution lines. An alternative would be to utilize a ball-type relief valve, where the ball normally rests above the wye at the junction and then would get lodged inside the opposite side's line to facilitate one-way travel of the compressed gas. The pneumatic actuator is normally extended via its captive coil spring and is forced to retract when the compressed gas enters its body. The decompression panel's pneumatic actuator is activated which provides the force necessary to release the deadbolt bars of the decompression panel located in the door.

Mounting of the differential pressure diaphragm can be accomplished in either the decompression panel or in the door itself. For ease of illustration and simplicity of configuration, the decompression panel mounting position is provided herein.

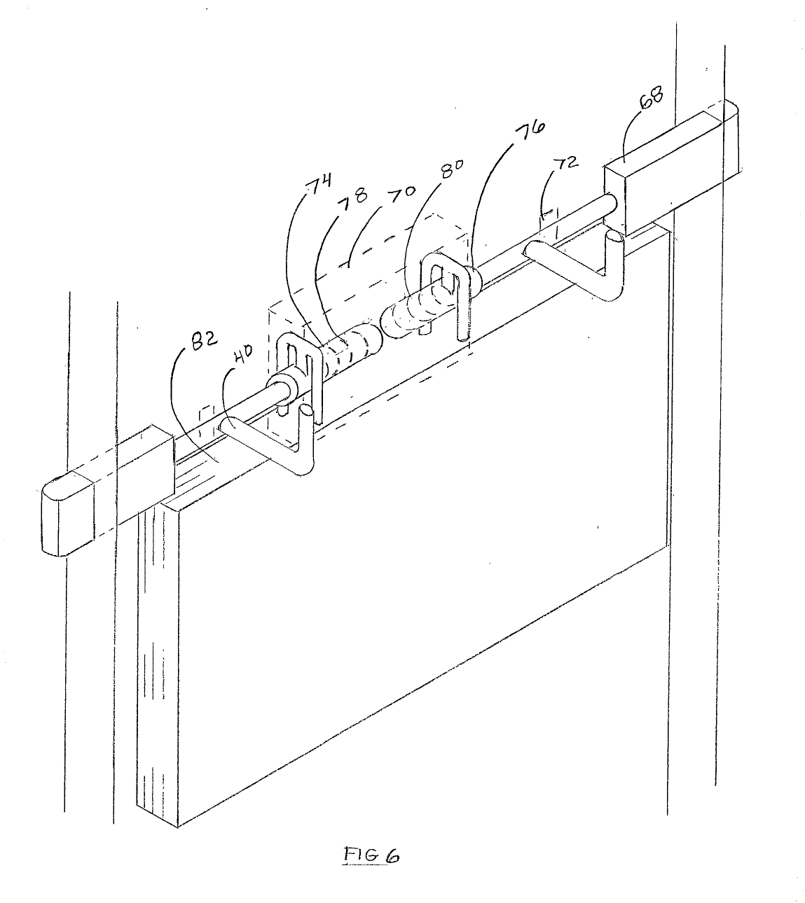

Referring next to FIG. 6, the normally closed position of both deadbolts 68 is provided. Phantoms lines are provided that depict where a typical mounting block 70 and plunger guides 72 would be located. Both pneumatic actuators 74 and 76 are depicted. The coiled springs 76 and 78 are depicted within each actuator via the phantom lines in their respective aft areas. The bellows diaphragm assembly 82 is in its neutral condition.

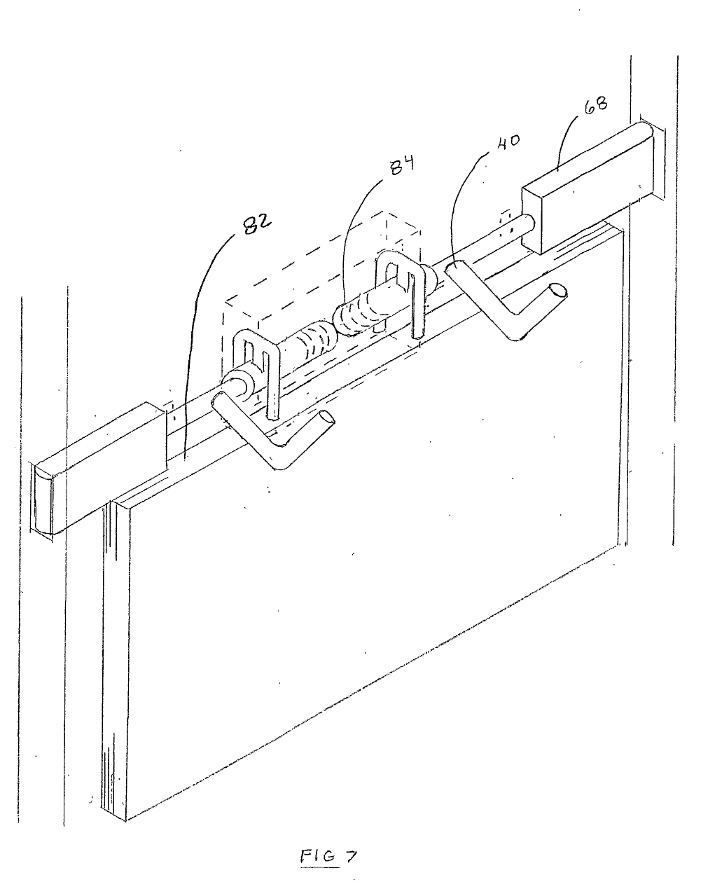

FIG. 7 shows the decompression panel in its release configuration. The bellows diaphragm assembly 82 has been compressed due the decompression event. The release levers 40 have been retracted and rest in their detents. And both deadbolts 68 are retracted. The decompression panel would now rotate downward, thereby helping to equalize cabin pressure.

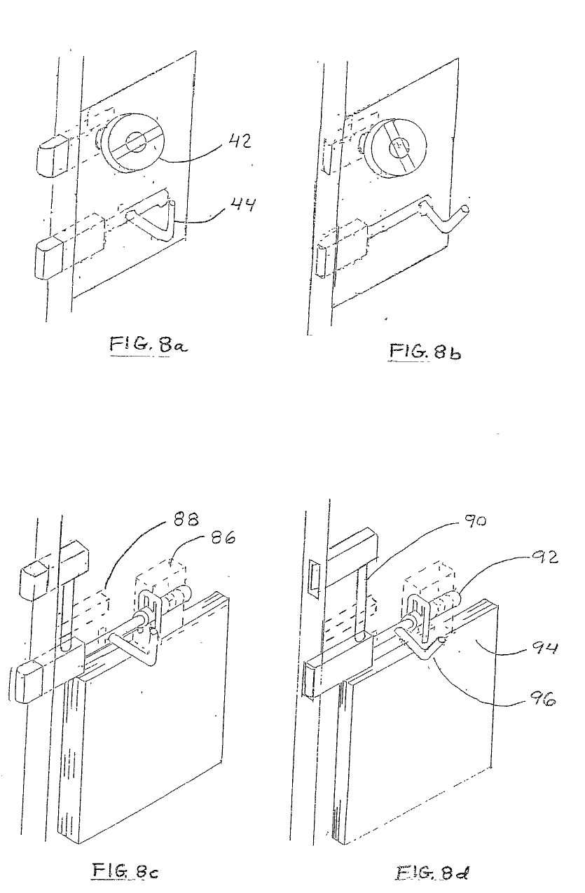

In FIG. 8, a series of lock and release sequences are shown for the door knob 42 and manual release lever 44. FIG. 8a shows the door knob deadbolt and manual release deadbolt in the locked position. FIG. 8b shows the door knob deadbolt and manual release deadbolt in the unlocked position. FIG. 8c provides a view of the door knob and deadbolt decompression mechanism in the locked or neutral position. The mounting block 86 for the single actuator and the bar guide 88 for the direct deadbolt link are also shown in FIG. 8c. While FIG. 8d provides a view of the deadbolt bar link 90 and the single door latch actuator 92. The door knob and deadbolt decompression mechanism 94 in the unlocked or compressed position and the release lever 96 in the detent position.

Other decompression assemblage options will now be described that are either electro-mechanical, electronic, or would be more complex than the embodiment presented at this time.

An alternate technique to provide the automated release feature is to measure differential pressure with pressure transducers. This is accomplished by mounting either a single differential pressure transducer in or near the protective door's framing, or mounting two pressure transducers, one near the pilot and the other in an inconspicuous place in the cabin, to provide the electrical signal to the pneumatic actuators that are utilized for the decompression panel and door latch.

Yet another technique of measuring such a rapid decompression event would be with a rate of inertia sensor. This sensor is typically a disc-shaped wafer and lends itself well to being mounted on or near the door latch. Sensitivity of the inertia sensor can be tuned to that of a decompression event and thus would be unresponsive to an attempted breach into the flight deck, firearms, or an explosion.

Still another method of automatically compensating for a rapid decompression event is to release the decompression panel in the flight deck door itself via a mechanical assembly composed of leaf springs, a coil spring, hinge, and cover. This device would look similar to a door hinge with a floating rectangular section in the middle. The thin leaf springs, typically five, would be approximately 0.006 in. thick stainless steel and are mounted perpendicular to the potential load or force. The floating cover is captivated by the hinge and employs relatively tight tolerances. The floating cover is what is displaced laterally in the event of decompression. The cover's response time is tuned to displace quickly and only when a decompression event occurs.

A manual release of the leaf spring assemblage is accomplished by a flipping a lever indicator approximately thirty degrees with a fingertip. This lever motion releases a coil spring that is wrapped around the pin of the hinge. The coil spring action forces the hinge to release its normally closed position, thereby allowing decompression panel to swing open. The response time of this lightweight subsystem would be fast, a feature that the FAA, Pilots Association, and airplane manufacturers such as Boeing may find attractive although it would add greater complexity than the aforementioned decompression panel subsystem.

Another method of providing the automatic release feature in the event of decompression would be realized by utilizing a pneumatic actuator linked with an over-center cam on the door latch. The over-center mechanism for the door latch could satisfy the FAA's requirements if the decompression panel requirement is changed. An air cylinder would provide the energy to rotate the over-center mechanism on the door latch. This pneumatic actuator would receive its decompression event signal from either a differential pressure transducer or an inertia sensor built into the door latch.

A versatile, yet more complex door latch system is realized with an electro-mechanical assembly. Here a pair of solenoids is employed to release the latch from the door strike, when a decompression differential pressure is sensed via pressure transducer or inertia sensor.. Release times of these air cylinder actuated or solenoid actuated door latches would be fast, perhaps as quick as four milli-seconds.

Thus with the aforementioned adjustable (differential pressure diaphragm, or differential pressure transducer, or inertia sensor) features, the decompression panel and the door lock/release mechanism can be adjusted to automatically release only in the event of cabin decompression and not from an attempted forced entry or impact from weapons or axes.

With normal operating conditions, stowage or securing of the panel-type door in the open position is accomplished via a conventional hook and eyelet arrangement mounted on the side-wall of the cockpit entranceway.

A second embodiment of the Protective Shield for Aircraft Cockpit Crew, a bi-fold hinged panel door, is readily achieved for a flight deck entranceway. Like components of the referenced bi-fold panel hinged door are comprised of all the aforementioned components with the exception of component number 18 and 32 (the door itself), a protective T-channel is located at the bi-fold's joint, and a slight modification to the decompression panel assemblage. Those skilled in the art will readily see the ease with which the single panel door description previously provided can be readily modified as follows to achieve the desire configuration.

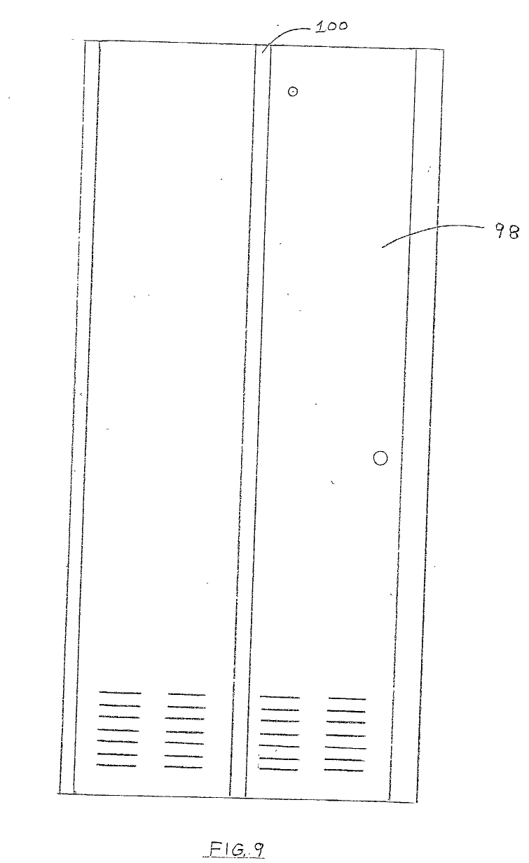

Shown in FIG. 9 is the protective bi-fold door 98 as viewed from the cabin. A protective T-channel is secured on two of its sides to on the inboard panel (nearest the hinges) of the bi-fold door. By installing this protective T-channel, the joint interface of the bi-fold door is protected when the door is in the closed position and has a smooth transition on the exterior face. Operation of the bi-fold door is conventional with the door know side being the one that moves toward the hinges.

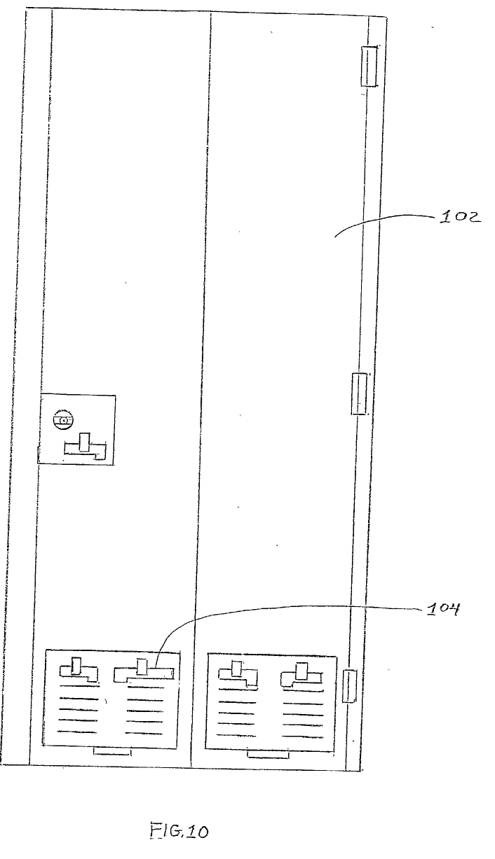

A view of the protective bi-fold door 102 from the cockpit is provided in FIG. 10. The decompression panel and its assemblage is smaller than the one previously described for the single panel door and fits in the same relative position, one in each panel of the bi-fold door. The travel of one of the release levers 104 is greater than the others due to the fact that it serves a dual purpose, that of decompression panel release and securing the inboard bi-fold's joint.

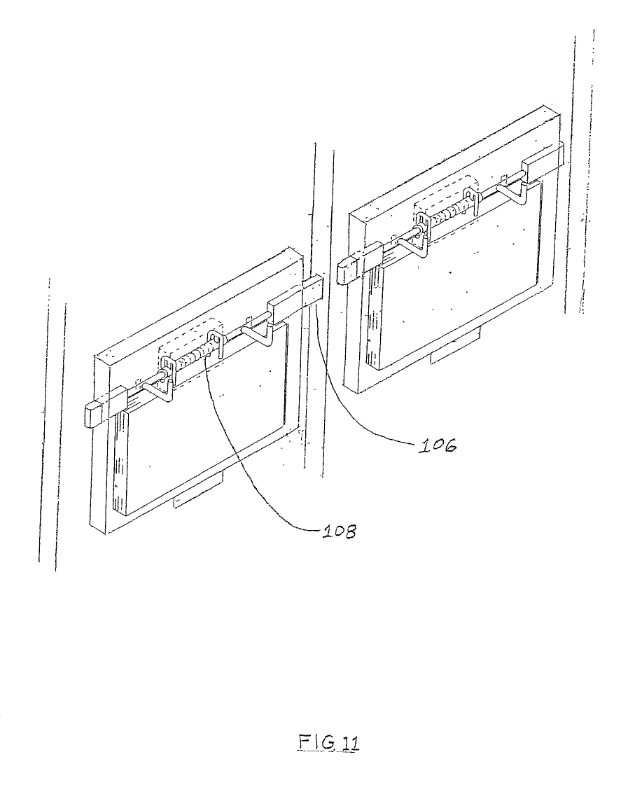

Referring now to FIG. 11, the extended travel of the one particular release lever can be viewed. This extended travel allows that release lever's deadbolt 106 to extend into the T-channel of the adjoining door panel. The local area of the T-channel where the deadbolt extends into is reinforced with high strength material. A pneumatic actuator 108 with a corresponding extended travel range is utilized for this particular deadbolt.

The same alternative door latch decompression devices and configurations exist for the bi-fold door as previously described for the single panel hinged door. Stowage of the bi-fold door is simple with the door folding upon itself and then being secured to the side wall via a hook and eyelet arrangement.

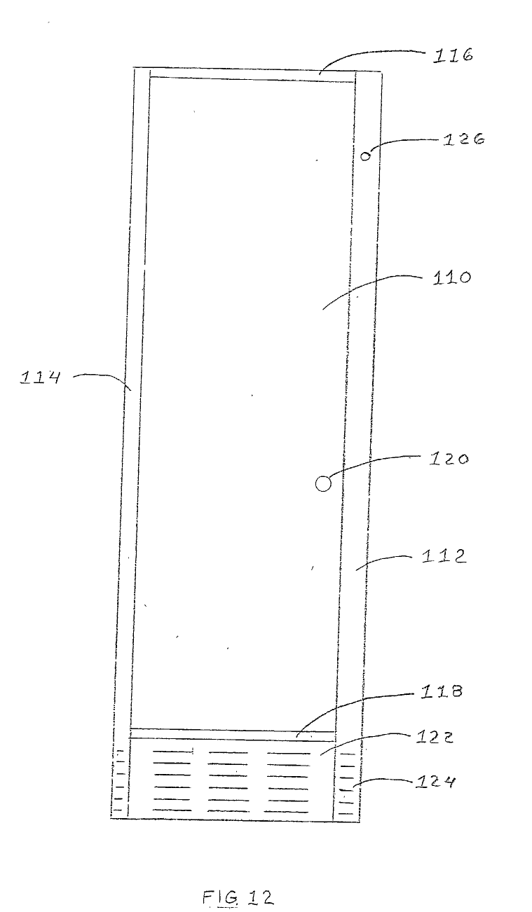

Referring now to FIG. 12, a third embodiment for the Protective Shield for Aircraft Cockpit Crew 18 is shown with the door being comprised of a roll-type panel embodiment 110 as viewed from the cabin. This protective shield system comprises a generally light-weight rectangular section of size corresponding to the aircraft cockpit's entranceway. This rectangular section can be comprised of a single panel of suitable thickness that is unrolled vertically into a closed position. The protective door is manufactured with composite materials such as “Spectra” or “Gold” or Kevlar” (or the patent pending material known as “TelAir”) and is processed such that a flexible panel results. The door is relatively stiff and has a rigid leading edge, yet is flexible enough to be rolled upon itself when it is uncoiled or recoiled during operation. The door 110 is slid from to side to side to achieve either a closed or open position.

Surrounding the protective door 110 is a strengthened door frame comprised of a doorjamb 112, and vertical frame 114. An upper guide track 1 16 and a lower guide track 118 are provided for the roll-type door to ride in while being closed or opened. The guide tracks are C-channel and provide the interior dimensions that closely match those of the upper and lower edge of the door 110. The door frame and guide tracks are made of high strength materials such as titanium or stainless steel. The strengthened door frame is secured to the aircraft structure via a plurality of fasteners per standard aircraft assembly procedures.

A door knob 120 is provided on the cabin side. The door 110 slides opened and closed in a conventional manner, similar to a pocket door. The door knob 120 is relatively small in diameter so that a large amount of force cannot be attained. Security bars are locked into place on the cockpit side thereby securing the door 110 is a closed position. Additional security features could be employed that include any one of the following methods for access to the flightdeck; coded key (one key issued to each airline/aircraft and tightly configuration-controlled), a locking door latch and handle, coded touch-pad (numeric or alpha-numeric), iris scan of eyeball (optical device), or finger-print scan (optical device).

From the cabin side, the decompression panel is located in the general area where the louvers 122 are seen. The louvers are made of a ballistic-proof material. The louvers 122 and a decompression panel assemblage are located below the door itself. In the event of the anomalous event known as decompression, the louvers allow the inherent differential pressure to trigger the decompression panel's automated release mechanism.

Located near the door louvers 122 is a pair of louvers shown on the side frame members, one of which provides the input for a differential pressure measurement that triggers an automated release of the door 110. The two side louvers provide an aesthetically appealing configuration as well as decoy for potential malicious tampering. Near the upper portion of the doorjamb 112 is a viewing port 126, equipped with a wide angle lens.

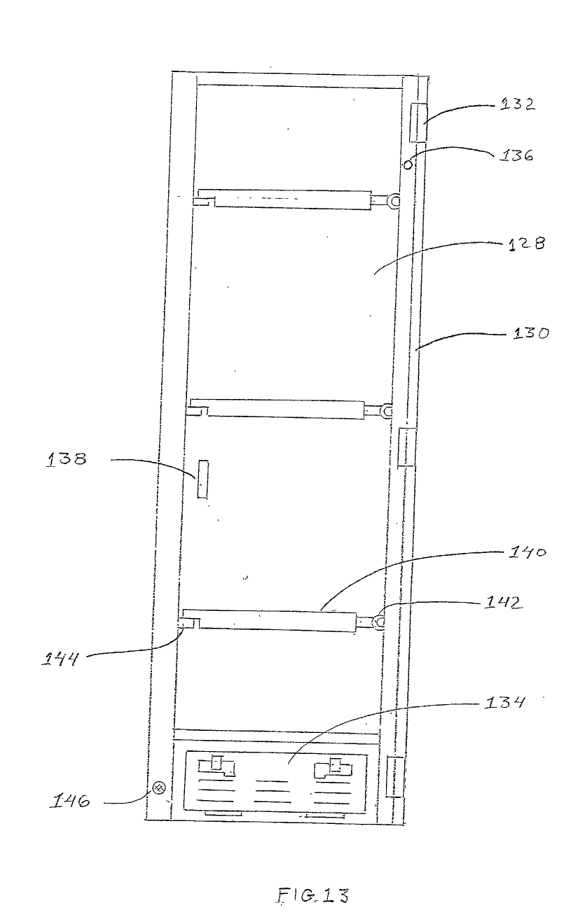

Next, FIG. 13 is provided that shows the protective shield system 18 as viewed from the cockpit side of the aircraft. Like components of the reference substructure are comprised of components 110, 112, 114, 116, and 118. The protective door 128 is secured in the housing 130 which is secured to the structure via a plurality of high strength hinges 132. Three hinges are shown in FIG. 13.

Located below the lower track guide 118 is a decompression panel 134. The decompression panel assemblage is comprised of like components 36, 38,40, and 48 through 84 and operates in the same manner.

A view port 136 is provided for use from the flight deck. A closed circuit digital camera system can be integrated with the view port to allow continuous monitoring (e.g. via LCD near pilot's console), as well as recording capability of the general cabin area.

A door handle 138 is provided for the roll-type protective door 128. The door handle provides the basic function of sliding the door from left to right. When the door is slid to the closed position over to the receptacle type of door jamb, a plurality of security bars are then rotated into position to lock the door in place. An additional security measure can be realized by integrating a locking feature in the door handle as well, similar to a door latch. A positive means of locking and releasing the door is thereby provided with the receptacle doorjamb, leading edge of door, and lock bar mechanical assemblage.

Security bars 140 are provided to lock the door closed and prevent any physical breach that may be attempted. Three security bars are shown in FIG. 13. The security bar is made of tubular titanium material and has one end of the bar flattened, drilled with a hole, and is permanently secured to an eyelet 142. The eyelet is secured to the housing 130, which is fastened to the aircraft structure. The security bars are stowed vertically when the door is open, and are secured to the housing 130 via Velcro straps.

The opposite end of the security bar 140 is also flattened and drilled with a hole to form an eyelet. There is a plurality of eyelets molded into the door 144 that matches the plurality of eyelets provided by the security bars. When the security bars are swung into a horizontal orientation, each of its eyelets overlaps with each of the door's eyelets thereby facilitating a locking feature. A differential pressure transducer 146 is mounted in the doorjamb frame. When a differential pressure threshold, such as 0.11 psig., is sensed then a signal is sent to the locking mechanism to release the door.

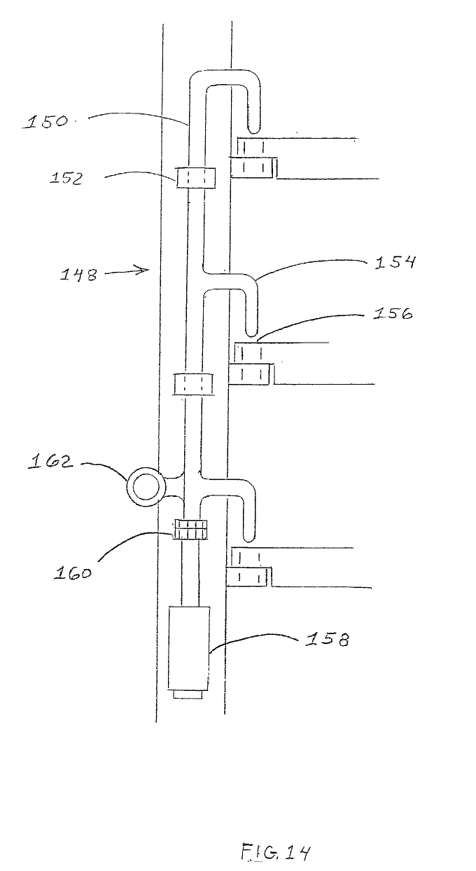

Presented in FIG. 14 is the locking mechanism 148 that engages each of the overlapping eyelets of the door and security bars and is mounted on the doorjamb 112. A common lock bar rod 150 slides vertically in the mounting block 152. The rod is made of high strength material such as titanium. There is a plurality of locking L-shaped hooks 154, integral to the lock bar, that mate with a matching plurality of overlapping eyelets 156. An open position of the lock rod is depicted in FIG. 14. To lock the door closed the bar would move downward vertically which would enable the L-shaped hooks to protrude through the overlapping eyelets.

An automated feature is provided via the pneumatic actuator 158 which would be utilized in the event of decompression. A threaded coupling 162 axially links the plunger of the actuator with the primary rod of the lock bar. The differential pressure transducer 146 provides the electrical signal (e.g. 0.5 to 4.25 Vdc range) to the pneumatic actuator 158 that would force the lock bar upwards and thereby release the door in the event of decompression.

The door is hinged about the housing and can swing either way, depending upon where the loss of cabin pressure is emanating from. A manual method of locking and releasing the door is accomplished by utilizing the door handle 162 to manually lift the lock bar into and out of its engaged position. A fail-safe configuration, automated in the event of decompression or normal manual operation, is thus provided for the door locking mechanism.

This lock bar mechanism could also be configured to be operate via an over-center cam mechanism that is fastened to the vertical rod of the locking bar mechanism. A purely mechanical automated release feature can be achieved by utilizing a differential pressure metallic bellows diaphragm subassembly 94 coupled with the lock bar 150. The corresponding decompression assemblage would be located within or next to the receptacle door jamb.

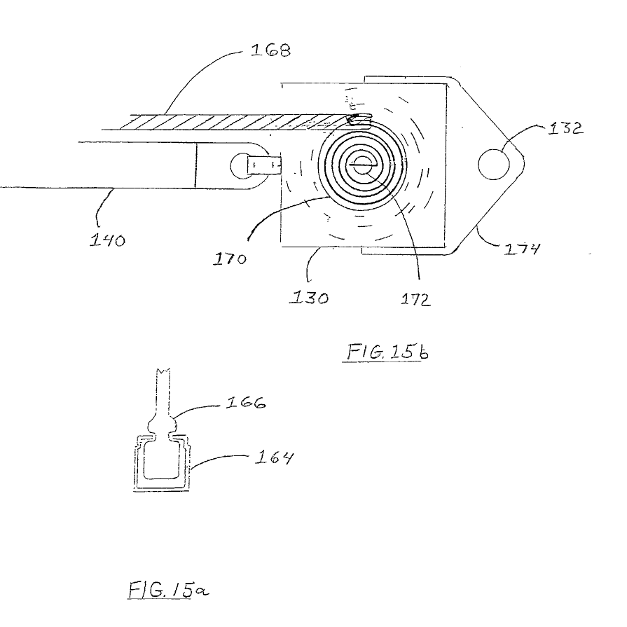

A cross-sectional view of the C-channel 164 guide track and door 166 is shown in FIG. 15a. The upper and lower edge of the door has a modified T-shape that rides inside the C-channel. The C-channel shape is such that it guides the upper and lower edge of the door as it slides along the linear path in which it travels. A top view of the door 168 is provided in FIG. 15b. The edge of the door is fastened to the coil spring spool assembly 170 via standard aircraft assembly procedures (e.g. bonding and rivets). The vertically oriented axle assembly 172 (axle, upper and lower sleeve bearing, upper and lower hub) rotates within the housing 130. The housing also serves as a stowage container for the door when it is in a stowed or open position. The stowage container is a rectangular shaped box with a square shape cross section. The housing is hingely installed on the side wall of the cockpit entranceway to house the shield's panel.

The spool assembly 170 is rotatably driven by the coil drive spring, shown in FIG. 15b, and is housed within the housing. The spring is positioned to provide tension and drive the spool assembly clockwise, the winding up of the spring being effected by the counterclockwise rotation of the spool assembly resulting from the unwinding (i.e. opening) of the protective door from about the spool as the panel is pulled out from the housing assemblage. The spool assembly is free to rotate in the clockwise direction via its inherent tensioning characteristics, the rotation thereof in this direction being balanced by the lightweight door. The recoil and uncoil mechanism is similar to that employed in a Venetian Blind and is well established in functionality. The door is kept in a closed position by the overlapping eyelets and manually engaging the locking mechanism.

Either a manually operated shield or a motorized version can be employed for closure/opening of the protective shield system. For ease of description and illustration herein, a manually operated protective shield is described in detail. Those skilled in the art will readily see how the protective shield system could be motorized thereby enabling an automated closure and opening of said system.

The invention therefore provides an improved system to improve aircraft technology, provide a greater level of security aboard an airplane, protect airplane passengers and operators thereof from the terrorist actions of hijackers and anomalous events. In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. It is therefore understood that modifications to the invention may be made as might occur to one with skill in the field of the invention within the scope of the appended claims. The present embodiments are, therefore, to be considered as merely illustrative and not restrictive, the scope of the invention being indicated by the claims rather than the foregoing description, and all changes which come within the meaning and range of equivalence of the claims are therefore intended to be embraced therein.

What I claim is:

1. A protective shield system to safeguard the crew from forceful intrusions and weapons that is light weight, high strength and is installed in the aircraft cockpit entranceway and is comprised of: (a) a weapon-proof rectangular shield panel having height and width; (b) a frame wherein said shield has one edge interconnected to the surrounding structure; and (c) a locking mechanism to secure said shield in a closed position.

2. The protective shield system of claim 1, wherein said rectangular shield is comprised of at least one panel, said panel being made of lightweight layered composite material, said panel having at least one frame, thereby comprising a door.

3. The protective shield system of claim 2, wherein said door has at least one decompression panel that releases from said door in the event sudden pressure differential in the aircraft.

4. The protective shield system of claim 2, wherein said door has a device to enable viewing from the cockpit side only.

5. The protective shield system of claim 1 further including a doorframe wherein one edge of said door is connected via a plurality of hinges.

6. The protective shield system of claim 1 wherein said lock/release mechanism provides the physical means to lock said door closed and to release said door prior to opening.

7. The protective shield system of claim 1 wherein said lock/release mechanism provides the automated means to release said decompression panel and/or said door.

8. The protective shield system of claim 1 wherein said panel is made of lightweight layered composite material; includes at least one decompression panel or latch; has a view port into the cabin; is hingely connected to the aircraft structure, and has a manual means and an automated means of unlocking.

9. A protective shield system to safeguard the crew from forceful intrusions and weapons that is light weight, high strength and is installed in the aircraft cockpit entranceway and is comprised of: (a) a weapon-proof rectangular shield panel having height and width; (b) a frame wherein said shield has one edge interconnected to the surrounding structure; and (c) a locking mechanism to secure said shield in a closed position; wherein said shield is comprised of a roll of light weight layered composite material.

10. The protective shield system of claim 9 further including a plurality of cross members.

11. The protective shield system of claim 9 further including a device to enable viewing of the cabin from the cockpit side.

12. The protective shield system of claim 9 further including at least one guide track.

13. The protective shield system of claim 9 further including at least one decompression panel that releases in the event of sudden pressure differential in the aircraft.

14. The protective shield system of claim 9 wherein the lock/release mechanism provides the physical means to lock said shield closed and to release said shield prior to opening.

15. The protective shield system of claim 9 wherein the lock/release mechanism provides the means to automatically release said shield.

16. The protective shield system of claim 9 wherein said panel is made of lightweight layered composite material; includes at least one decompression panel or latch; has an upper and lower guide track; has a view port into the cabin; is hingely connected to the aircraft structure, and has a manual means and an automated means of unlocking.

17. A protective shield system to safeguard an aircraft crew from unauthorized forceful access to the cockpit of an aircraft by persons in the passenger or cargo areas of the aircraft, comprising:
a transverse bulkhead within an aircraft defining a door opening and having a door frame;
a panel constituting a door being located within said door opening for opening and closing movement, said panel being reinforced against penetration by weapons, tools and explosives and having a panel opening;
door mounting structure supporting said door for opening and closing movement relative to said door frame and being of sufficient structural integrity to resist breakage by weapons, tools and explosives, thus ensuring the security integrity of said door when closed;
a locking mechanism being mounted to said door and to said door frame and being manually actuatable only from within the cockpit;
a reinforced panel comprising said door within said door panel opening and having a locking mechanism retaining said reinforced panel in place; and
a decompression responsive unlocking mechanism releasing said locking mechanism of said reinforced panel responsive to decompression.
